(19) United States
(12) Patent Application Publication
(10) Pub. No.: US 2026/0134382 A1
(43) Pub. Date: May 14, 2026

(54) System and Method for Optimized Inbound Execution

(71) Applicant: Blue Yonder Defense Solutions, LLC, Dallas, TX (US)

(72) Inventors: Ranjit Notani, Plano, TX (US); Gregory Allan Brady, Dallas, TX (US); Eric Rodriguez, Hurst, TX (US); Yogesh Sharma, Frisco, TX (US); Nageen Athmuri, Flower Mound, TX (US)

(21) Appl. No.: 19/381,036

(22) Filed: Nov. 6, 2025

Related U.S. Application Data
(63) Continuation of application No. 18/596,100, filed on Mar. 5, 2024.

(51) Int. Cl. G06Q 10/0835

(52) U.S. Cl. CPC G06Q 10/0835

(57) ABSTRACT

A system and method for computer program product embodied on a computer readable medium for optimized inbound execution, the computer program product including managing an overall workflow to develop a movement schedule, securing a delivery appoint on a customer requested delivery date, generating a feasible movement schedule and milestone set beginning with a target pickup appointment window utilizing distance, drive or rest time regulations and facility operating schedules, scheduling a pickup up appointment, issuing a tender to a carrier having pickup and delivery appointments already applied, and confirming the pickup and delivery appointments.

### CROSS-REFERENCE TO RELATED APPLICATIONS

This application is a continuation of U.S. patent application Ser. No. 18/596,100 filed Mar. 5, 2024. The entire disclosure of the above application is incorporated by reference.

### FIELD

The present invention is generally related to multi-enterprise synchronization of orders, shipments, and resources associated with the efficient procurement and transfer of products between Supplier and Customer enterprises and, more particularly, to methods, processes and systems for optimizing Supplier delivery performance and asset utilization while minimizing cost and supporting infrastructure requirements across the combined resources of the trading partner enterprises.

### BACKGROUND

In an increasingly global economy, business enterprises of all types are faced with the challenge of managing and optimizing ever more complex supply chains. These supply chains, often called “value chains,” are characterized by a high degree of collaboration, cooperation, and interdependency between the enterprise and other entities or partners in the chain. A value chain may include, for example, raw materials producers, component manufacturers, distributors, carriers and the like. The business goal of managing and optimizing a value chain is to minimize the costs incurred by all participants in the chain while maintaining a high level of customer service and maximizing profits. In order to achieve this goal, the enterprise strives to reduce the quantity of stored goods in the value chain, while minimizing opportunity loss by maintaining a sufficient inventory level to satisfy customer demand. There exist many deficiencies in optimizing a value chain and in particular deficiencies in optimizing the inbound execution of a value chain.

### SUMMARY

Accordingly, one aspect of the present invention is to provide a computer program product embodied on a computer readable medium for optimized inbound execution, the computer program product including (i) a first computer code for managing an overall workflow to develop a movement schedule, (ii) a second computer code for securing a delivery appoint on a customer requested delivery date, (iii) a third computer code for generating a feasible movement schedule and milestone set beginning with a target pickup appointment window utilizing distance, drive or rest time regulations and facility operating schedules, (iv) a fourth computer code for scheduling a pickup up appointment, (v) a fifth computer code for issuing a tender to a carrier having pickup and delivery appointments already applied, and (vi) a sixth computer code for confirming the pickup and delivery appointments.

### BRIEF DESCRIPTION OF THE DRAWINGS

A more complete appreciation of the present invention and many of the attendant advantages thereof will be readily obtained as the same becomes better understood by reference to the following detailed description when considered in conjunction with the accompanying drawings, wherein:

FIGS. 1A-1E are block diagrams illustrating systems for optimized inbound execution in accordance with an embodiment of the present invention.

FIG. 2 is a flow chart illustrating a method for optimized inbound execution in accordance with an embodiment of the present invention.

### DETAILED DESCRIPTION

Referring now to the drawings, wherein like reference numerals designate identical or corresponding parts throughout the several views, preferred embodiments of the present invention are described.

Within the extended value chain, individual enterprises typically model various processes, functions and operations across the tiers and nodes under its direct operational control. An enterprise primarily engaged in consumer-facing retail operations will model its stores and their supporting distribution centers along with fulfillment centers supporting consumer direct sales. A supplying enterprise typically models multiple nodes in one or more distribution tiers along with its internally operated and/or contract manufacturing nodes. Each enterprise deploys varies tools and processes designed to anticipate future demands, net them through existing inventories and service-specific safety levels to produce a time-phased “forecasts of orders” expected to be sold, moved, or procured. Built into these models are lead time offsets that reflect the process and transit time required to actually plan, schedule, and move physical products from node to node.

Both the time-horizon over which order forecasts are generated and the level of time and dimensional granularity varies by industry and type of enterprise. A retail enterprise my generate item and store specific order forecasts at least daily for one to two weeks into the future. A supplier may generate a daily movement forecast between plant and forward distribution center for four to six weeks followed by an additional twelve to eighteen months in weekly or monthly time increments. From these time-phased “arrays” of order forecasts for specific products or materials at each site, enterprises can extrapolate various aggregate resource requirements including, without limitation, shelf and storage space, material handling machine and labor capacity, transport assets and driver requirements, production equipment, raw materials and plant staffing levels, and the like.

As comprehensive and integrated as the internal supply chain process and tools may be, when the enterprise boundary is approached and it is time to transfer demands and/or materials between enterprises, the predominant method of doing so remains the individual, discrete purchase order (which become a sales order for the supplying enterprise). It is a single point in time transactional request to buy one or more items and typically includes, without limitation, requested product, quantity, delivery site, delivery date, expected unit transfer price and the like. None of the built-in intelligence, knowledge of specific business activities and benefits of forward planning in the buying enterprise with respect to future inbound demand are transferred across the boundary to the supplying enterprise. The supplier is left in a position of having to duplicate effort and generate a completely new set of projected order forecasts for each supplied customer enterprise, the sum which is assumed to represent that aggregate outbound demand for the supplier. Differences in visibility to orders and inventory, assumptions, and approach result in frequent mismatches between the customer and supplier enterprises as to what the short and mid-term levels of activity are likely to be. This requires the supplier to hedge this uncertainty with inventory, excess capacity and larger infrastructure that all increase costs.

The purchase order itself is typically created by a buying or procurement group solely by evaluating existing supply against short-term usage or consumption with the deficit becoming the new line-item order quantity. This evaluation is typically done one item at a time. Multiple item requirements are then grouped using supplier provided rules around common source sites to build “shippable” multi-line-item orders. The subsequent purchase orders are then transmitted to the supplier. Note that nothing in the current process checks the feasibility of executing the purchase order against the customer enterprise's own resources. The requested PO delivery date may correspond to a date where the delivery site's own receiving capacity has already been over consumed, the site's storage capacity has been exceeded, etc.

Once in receipt of the purchase order, the supplier currently processes it through a sequential set of tasks: audit, credit check, sourcing validation, supply availability checking. If a quantity ordered is not available in full, a period of negotiation and collaboration between customer's buyer and supplier's customer service representative (CSR) ensues to finalize the PO/SO.

Then the order is passed to the transportation organization responsible for managing the actual move. It may be the supplier's (prepaid) OR the customer's (collect) depending on the lane and order terms. The order must be converted to a shipment and tendered to one or more carriers. Upon award and acceptance, the assigned carrier must then pivot and coordinate with the customer's DC operations group to secure a slot for delivery at the destination site. This can occur days after the creation of the PO. This is typically accomplished via a portal or mobile application provided by the dock scheduling services provider at the customer's facility. Similarly, a pickup appointment must be secured at the supplier's shipping site that is consistent with both the transit time on the route and the delivery appointment. The time lapse from the facts utilized to generate the initial PO until the carrier's transport equipment arrives at the supplier's shipping site for loading is known as the order to ship (OTS) lead time. It is currently measured in multiple days. It can be multiples of the actual physical time: loading, transit, and unloading.

The process scope described above spans multiple enterprises, multiple organizations within each enterprise and multiple systems/tools. The steps are done sequentially in a lengthy process. There is no single process orchestrator that monitors and provides all relevant parties with common visibility into all current states of order fulfillment across the enterprise boundary. Breakages and process failure detection are random and unsystematic. The scramble to recover and repair from those failures is labor intensive and costly. In order to maintain desirable levels of service, all parties currently hedge with excess inventory, increased headcount, larger infrastructure, and excess overall capacity.

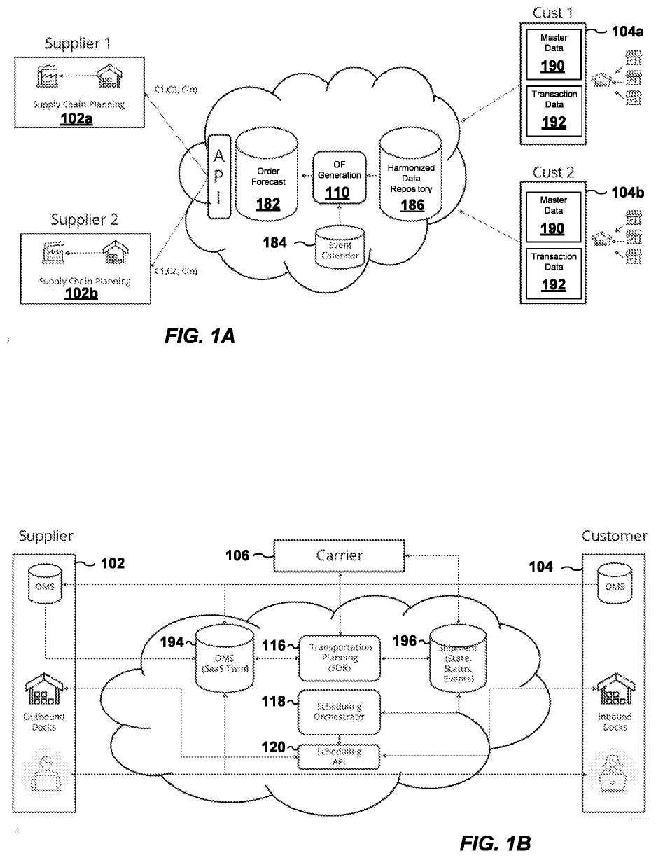

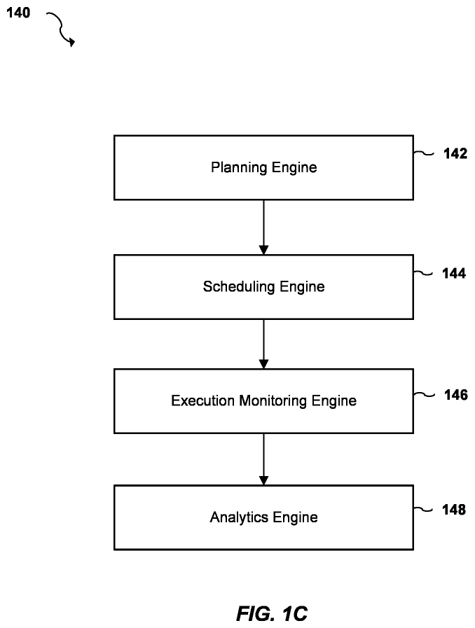

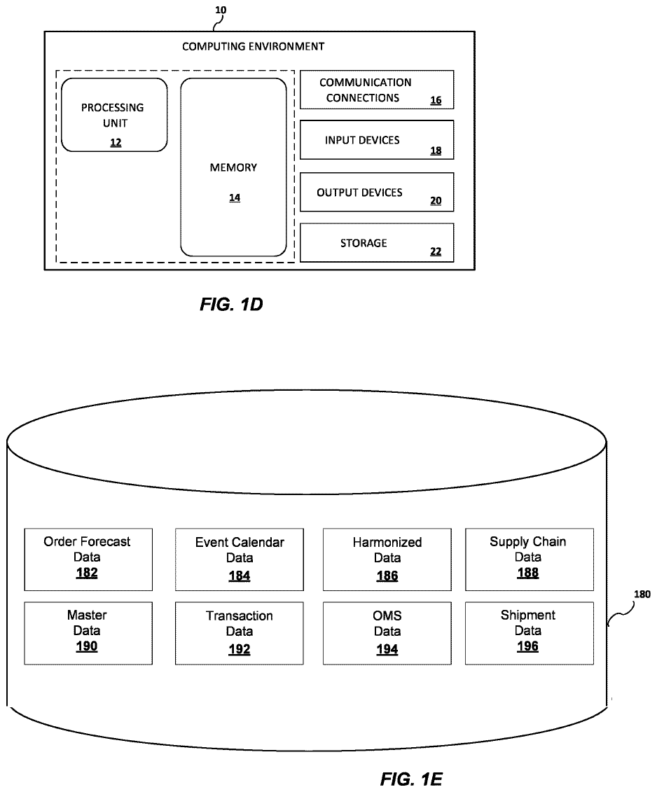

Referring to FIGS. 1A-1E, block diagrams illustrating optimized inbound execution are shown. As shown in FIG. 1A, the system of the present invention may include one or more suppliers 102a-102b and one or more customers 104a-104b. The system may also include order forecast data 182, harmonized data 186, and event calendar data 184 which is utilized by OF generation 110. As shown in FIG. 1B, the system of the present invention may include one or more suppliers 102, one or more customers 104 and one or more carriers 106. The system may also include order OMS data 194 and shipment data 196 which is utilized by transportation planning (SOR) 116, scheduling orchestrator 118 and scheduling API 120.

As shown in FIG. 1C (140), the present invention includes without limitation, a planning engine 142, a scheduling engine 144, an execution monitoring engine 146 and an analytics engine 148.

The planning engine 142 is responsible for continually updating the generation and sharing item and site level order forecasts between customer and its suppliers for the purpose of material procurement, production scheduling and positioning of products properly with the suppliers'enterprise in anticipation of receipt of formal sales orders. Using the planning engine 142, the system formats confirmed quantities shipped against each order line item and transmits an advanced shipment notice (ASN) to the customer to facilitate efficient receipt of goods and improve the quality of subsequent replenishment planning cycles. The system then registers the asset ID of the transporting equipment, which facilitates generated GPS coordinates to be collected at regular intervals associated with the asset ID. The system then continuously tracks the physical movement of the asset against a set of milestones to determine if the current ETA is consistent with the established delivery appointment. Should the system detect a delay push shipment computed arrival beyond its currently scheduled delivery appointment window, the current appointment is automatically cancelled (released for use by another resource) and a new, ETA consistent appointment is scheduled. The system then notifies all relevant parties of the change in schedule.

The scheduling engine 144 is responsible for scheduling the rapid development, on a transactional basis, of a comprehensive, feasible schedule of tasks required to affect the transfer of goods between supplier, carrier and customer such that all parties have a common, real-time perspective on the state of required task for each order and associated shipment(s).

The execution monitoring engine 146 is responsible for the continual monitoring, alerting, and display to all relevant parties of executional deviations and propagated impact from the developed, feasible schedule to all associated parties inclusive of either autonomously executed or prescribed corrective measures.

The analytics engine 148 is responsible for the continual analysis of historical transactions to identify and rank root causes along with service and cost impact on process efficiency. Using the analytics engine 148, the system generates standardized on time pickup and delivery trends at multiple levels to identify the highest and lowest performing subsets of the value chain, which is used to provide a feedback mechanism to drive continuous improvement. These levels include without limitation (i) supplier to customer aggregate level, (ii) customer delivery site level, (iii) supplier shipping site, (iv) lane level, (v) servicing carrier level. Standardized reason codes enable drill down and determination of the actual root cause of performance failures. The system includes a robust set of pre-configured widgets which enable relevant parties to further configure analytics that match specific concerns (or “care abouts”).

The value chain orchestration program of the invention is an event-driven solution that updates the data in the value chain whenever a value chain state change occurs, resulting in the most recent data being used. Moreover, the new techniques in this invention are able to identify and process only the portion of the value chain that is affected by the state change instead of the entire value chain, thereby reducing processing time tremendously. The exemplary value chain management program then uses the up-to-date value chain data to determine whether any actions or changes are needed to the affected portion of the value chain plan.

The planning engine 142 is responsible for the generation and exchange of short-term order forecasts between entities within the value chain. For instance, between customers and suppliers. The planning engine 142 utilizes master data 190 and transaction data 192. Master data 190 includes, without limitation, store sites, distribution center sites, items stocked by store, items stocked by site, distribution center to store sourcing relationship, inventory stocking and ordering rules by item or store, inventory stocking and ordering rules by item or DC, and the like. Transaction data 192 includes, without limitation, POS (point of sale) by item or store, item store on hand, item store in transit, item store open orders, item store short-term forecast, DC item on hand, DC open purchase order, item DC short-term forecast, and the like.

Each customer and supplier collaboratively develop and maintain a joint calendar to document upcoming volume-impacting events including, without limitation, new product introductions, product phase outs, promotional activity, and the like. Each event includes, without limitation, item(s) impacted, site(s) impacted, begin or end dates, volume impact by item or site, initial supporting order quantity by site, and the like.

Within the platform, a universal repository is defined and continually updated when data from individual customers is aggregated and harmonized from a timeliness perspective. Standard platform service generates a time-phased projected delivery requirements into each customer distribution center for each item (order forecast). Suppliers leverage a platform API to subscribe to and pull these order forecasts into their internal supply chain planning and scheduling processes and tools for use in lieu of backwards looking statistically generated demand numbers. The order forecasts generated by this method leverage real-time consumption and inventory positions, thus allowing both the customer and suppliers to deliver superior service while lowering inventory, infrastructure and related operational costs.

The scheduling engine 144 is responsible for the automated generation or orchestration of a feasible transfer schedule of tasks required to affect the transfer of goods between trading partners on an “order by order” or transactional basis.

The order is “twinned” into the platform, either directly from the customer or from the supplier upon receipt. An order received directly from the customer is not duplicated if also subsequently transmitted to the platform from the supplier. Depending upon the sophistication of the customer's systems, it may or may not initially have a delivery appointment at this stage.

With the “twinned” order visible to both buyer and supplier service representative, proposed changes or modifications can be done with real time collaboration. The order is converted into a shipment by transportation planning.

The scheduling orchestrator manages the overall workflow to rapidly develop a complete, feasible movement schedule. If no delivery appointment was included in the original order, then the public scheduling API is leveraged to secure a delivery appointment on the customers buyer's requested delivery date.

The process is agnostic with respect to which technology service provider is controlling/assigning appointments for any given facility. After the delivery appointment is established, the scheduling orchestrator uses distance, drive or rest time regulations and facility operating schedules to generate a feasible movement schedule and milestone set beginning with a target pickup appointment window. The scheduling orchestrator then leverages the public scheduling API to secure a feasible pick-up appointment. The transportation planning SOR issues a tender to the carrier with both pickup and delivery appointments already applied. The assigned carrier then confirms the process generated appointments and/or modifies the pickup and delivery. After the delivery appointment is established, the scheduling orchestrator uses distance, drive or rest time regulations and facility operating schedules to generate a feasible movement schedule and milestone set beginning with a target pickup appointment window.

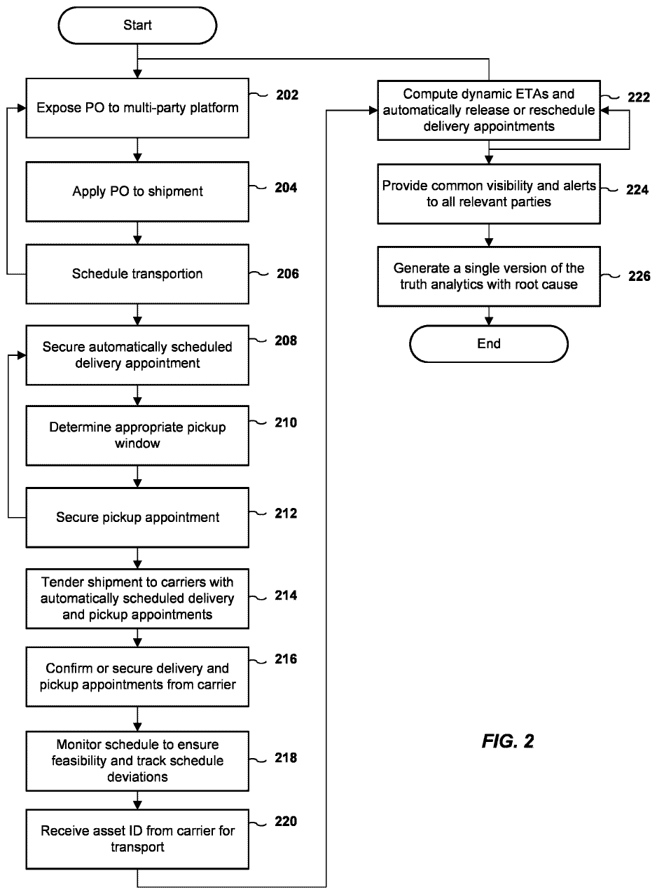

The order and associated shipment(s) are now fully scheduled, awaiting execution. Referring to FIG. 2, a flow chart illustrating a method for optimized inbound execution in accordance with an embodiment of the present invention, is shown. At block 202, a PO is exposed to a multi-platform platform. A PO is applied to a shipment, at block 204. At block 206, transportation is scheduled. A delivery appointment is automatically scheduled at block 208. Optionally, if there are any unplanned transportation, processing may return to block 202 and may trigger re-collaboration on purchase order.

At block 210, an appropriate pickup window is determined. A pickup appointment is secured at block 212. Optionally, if the schedules are not available, processing may return to block 208 in order to incrementally plan the shipments.

At block 214, a shipment is tendered to carriers with automatically scheduled delivery and pickup appointments. The delivery and pickup appointments are confirmed or secured from the carrier at block 216. At block 218, the schedule is monitored to ensure feasibility and track schedule deviations. An asset ID is received from carrier for transport at block 220. At block 222, dynamic ETAs are computed, and delivery appointments are automatically released or rescheduled. The released/rescheduled slots are reassigned to dropped loads in yard or loads entering the geo fence of the site. Block 222 may be repeated numerous times. Optionally, after Dynamic ETAs are computed, processing may return to block 202 in order to have the order have its optimization flow linked back to inventory.

Common visibility and alerts are provided to all relevant parties at block 224. At block 226, a single version of the truth analytics with root cause is generated.

As shown in FIG. 1D, the present invention includes a computer program product which may be hosted on a computer-usable storage medium 14 having computer-usable program code embodied in the medium and includes instructions which perform the processes set forth in the present specification on a processing unit 12. The storage medium 14 may include, but is not limited to, any type of disk including floppy disks, optical disks, CD-ROMs, magneto-optical disks, ROMs, RAMs, EPROMs, EEPROMs, flash memory, magnetic or optical cards, or any type of media suitable for storing electronic instructions. The computing environment may also include, without limitation, communication connections 16, input devices 18, output devices 20 and storage 22.

Computer program code for carrying out operations of the present invention may be written in any programming language including without limitation, object-oriented programming languages such as Java®, Smalltalk, C# or C++, conventional procedural programming languages such as the “C” programming language, visually oriented programming environments such as VisualBasic, and the like.

Obviously, many other modifications and variations of the present invention are possible in light of the above teachings. The specific embodiments discussed herein are merely illustrative, and are not meant to limit the scope of the present invention in any manner. It is therefore to be understood that within the scope of the disclosed concept, the invention may be practiced otherwise then as specifically described.

1. (canceled)

2. A system for optimizing inbound execution comprising:
a scheduling module configured to:
determine a movement schedule from a first entity to a second entity, wherein determining the movement schedule includes:
determining whether a first communication includes a first event;
in response to a determination that the first communication does not include the first event, automatically, without user intervention:
determining a second event, wherein the second event is based on a deadline set by the second entity,
determining a third event based on the second event and a set of event factors, and
electronically transmitting the movement schedule including the second event and the third event to the first entity, the second entity, and a third entity; and
in response to a determination that the first communication includes the first event, automatically, without user intervention:
determining the third event based on the first event and the set of event factors, and
electronically transmitting the movement schedule including the first event and the third event to the first entity, the second entity, and the third entity.

3. The system of claim 2, further comprising a planning module configured to:
automatically collect an identification number of an asset associated with the third entity,
based on the identification number, automatically collect a set of location coordinates associated with the asset,
based on the set of location coordinates, automatically determine a temporal correlation between a future location of the asset and a location of the third event,
automatically determine whether the temporal correlation meets a time threshold defined by the third event, and
in response to a determination that the temporal correlation does not meet the time threshold defined by the third event, automatically:
determine a fourth event,
transmit the fourth event to the first entity, the second entity, and the third entity, and
flag a time window associated with the third event for reassignment.

4. The system of claim 3, wherein the set of location coordinates is a set of global positioning system (GPS) coordinates.

5. The system of claim 3, wherein the planning module is configured to automatically:
generate a set of order forecasts, and
transmit the set of order forecasts to the first entity and the second entity.

6. The system of claim 5, further comprising:
a repository storing data associated with the second entity,
wherein the set of order forecasts is based on the data associated with the second entity.

7. The system of claim 2, wherein the set of event factors includes:
the second event,
a distance between a first location and a second location,
an operation schedule of the first location,
an operation schedule of the second location, and
a set of transportation restrictions associated with the third entity.

8. The system of claim 2, wherein the scheduling module is configured to, in response to transmitting the movement schedule to the third entity:
in response to a first user input, confirm the movement schedule, and
in response to a second user input, modify the movement schedule.

9. The system of claim 2, further comprising an analytics engine configured to:
automatically analyze historical data to identify root causes of performance failures, and
automatically rank the root causes based on an associated efficiency impact level.

10. A non-transitory computer-readable storage medium comprising processor-executable instructions, wherein the instructions include:
determining a movement schedule from a first entity to a second entity, wherein determining the movement schedule includes:
determining whether a first communication includes a first event;
in response to a determination that the first communication does not include the first event, automatically, without user intervention:
determining a second event, wherein the second event is based on a deadline set by the second entity,
determining a third event based on the second event and a set of event factors, and
electronically transmitting the movement schedule including the second event and the third event to the first entity, the second entity, and a third entity; and
in response to a determination that the first communication includes the first event, automatically, without user intervention:
determining the third event based on the first event and the set of event factors, and
electronically transmitting the movement schedule including the first event and the third event to the first entity, the second entity, and the third entity.

11. The non-transitory computer-readable storage medium of claim 10, wherein the instructions include:
automatically collecting an identification number of an asset associated with the third entity,
based on the identification number, automatically collecting a set of location coordinates associated with the asset,
based on the set of location coordinates, automatically determining a temporal correlation between a future location of the asset and a location of the third event,
automatically determining whether the temporal correlation meets a time threshold defined by the third event, and
in response to a determination that the temporal correlation does not meet the time threshold defined by the third event, automatically:
determining a fourth event,
transmitting the fourth event to the first entity, the second entity, and the third entity, and
flagging a time window associated with the third event for reassignment.

12. The non-transitory computer-readable storage medium of claim 10, wherein the instructions include:
generating a set of order forecasts, and
transmitting the set of order forecasts to the first entity and the second entity.

13. The non-transitory computer-readable storage medium of claim 10, wherein the set of event factors includes:
the second event,
a distance between a first location and a second location,
an operation schedule of the first location,
an operation schedule of the second location, and
a set of transportation restrictions associated with the third entity.

14. The non-transitory computer-readable storage medium of claim 10, wherein the instructions include, in response to transmitting the movement schedule to the third entity:
in response to a first user input, confirming the movement schedule, and
in response to a second user input, modifying the movement schedule.

15. The non-transitory computer-readable storage medium of claim 10, wherein the instructions include:
automatically analyzing historical data to identify root causes of performance failures, and
automatically ranking the root causes based on an associated efficiency impact level.

16. A method comprising:
determining a movement schedule from a first entity to a second entity, wherein determining the movement schedule includes:
determining whether a first communication includes a first event;
in response to a determination that the first communication does not include the first event, automatically, without user intervention:
determining a second event, wherein the second event is based on a deadline set by the second entity,
determining a third event based on the second event and a set of event factors, and
electronically transmitting the movement schedule including the second event and the third event to the first entity, the second entity, and a third entity; and
in response to a determination that the first communication includes the first event, automatically, without user intervention:
determining the third event based on the first event and the set of event factors, and
electronically transmitting the movement schedule including the first event and the third event to the first entity, the second entity, and the third entity.

17. The method of claim 16, further comprising:
automatically collecting an identification number of an asset associated with the third entity,
based on the identification number, automatically collecting a set of location coordinates associated with the asset,
based on the set of location coordinates, automatically determining a temporal correlation between a future location of the asset and a location of the third event,
automatically determining whether the temporal correlation meets a time threshold defined by the third event, and
in response to a determination that the temporal correlation does not meet the time threshold defined by the third event, automatically:
determining a fourth event,
transmitting the fourth event to the first entity, the second entity, and the third entity, and
flagging a time window associated with the third event for reassignment.

18. The method of claim 16, further comprising:
generating a set of order forecasts, and
transmitting the set of order forecasts to the first entity and the second entity.

19. The method of claim 16, wherein the set of event factors includes:
the second event,
a distance between a first location and a second location,
an operation schedule of the first location,
an operation schedule of the second location, and
a set of transportation restrictions associated with the third entity.

20. The method of claim 16, further comprising, in response to transmitting the movement schedule to the third entity:
in response to a first user input, confirming the movement schedule, and
in response to a second user input, modifying the movement schedule.

21. The method of claim 16, further comprising:
automatically analyzing historical data to identify root causes of performance failures, and
automatically ranking the root causes based on an associated efficiency impact level.
